(19) United States
(12) Patent Application Publication
(10) Pub. No.: US 2014/0164573 A1
(43) Pub. Date: Jun. 12, 2014

(54) DATA TRANSMISSION SYSTEM AND METHOD

(71) Applicant: ASUSTeK COMPUTER INC., Taipei (TW)

(72) Inventors: Chung-Liang HSIAO, TAIPEI (TW); Chih-Yi CHEN, TAIPEI (TW); Ming-Bin LIN, TAIPEI (TW); Yuan-Jui HUANG, TAIPEI (TW); Wei-Ching CHUNG, TAIPEI (TW)

(73) Assignee: ASUSTeK COMPUTER INC., Taipei (TW)

(21) Appl. No.: 14/097,270

(22) Filed: Dec. 5, 2013

Related U.S. Application Data
(60) Provisional application No. 61/736,496, filed on Dec. 12, 2012.

(30) Foreign Application Priority Data
Apr. 15, 2013 (TW) 102113327

(51) Int. Cl. G06F 17/30

(52) U.S. Cl. CPC G06F 17/30165
USPC 709/219

(57) ABSTRACT

A data transmission system includes a plurality of electronic devices, an verification server, and at least one access server. The electronic devices are verified by the verification server, and a data transmission group formed by the verified electronic devices. A receiving end in the data transmission group sends a command to the rest of the electronic devices in the data transmission group by the verification server. When the rest of the electronic devices receive the command, the rest of the electronic devices output metadata to the access server. The receiving end receives the metadata via the access server. The receiving end requests the transmitting end in the data transmission group for a physical file according to the metadata. The transmitting end transmits the physical file to the access server, and the access server transmits the physical file to the receiving end.

### CROSS-REFERENCE TO RELATED APPLICATION

This application claims the priority benefit of U.S. provisional application Ser. No. 61/736,496 filed on Dec. 12, 2012 and Taiwan application serial No. 102113327, filed on Apr. 15, 2013. The entirety of the above-mentioned patent application are hereby incorporated by reference herein and made a part of specification.

### BACKGROUND OF THE INVENTION

1. Field of the Invention

The invention relates to a data transmission system and method and, more particularly, to a data transmission system with a plurality of electronic devices and a method thereof.

2. Description of the Related Art

Data transmission among the electronic devices connected to Internet is usually executed via some transmission modes, such as FTP (File Transfer Protocol), Cloud Storage Space and STUN (Session Traversal Utilities protocol for NAT) protocol.

However, there are many limitations when using the file protocol for data transmission, meanwhile, there is a risk of data loss when a file is stored in a Cloud Storage Space. Moreover, some routers may not build connection between two electronic devices via the STUN protocol.

### BRIEF SUMMARY OF THE INVENTION

A data transmission system and method is provided.

A data transmission system disclosed herein includes a plurality of electronic device, a verification server, and at least an access server. The verification server is communicated and coupled with the electronic devices, the electronic, devices are verified by the verification server, and a data transmission is group formed by the verified electronic, devices, one electronic device of the data transmission group is used as a receiving end, the receiving end sends a command to the verification server, and the verification server receives and transmits the command to the rest of the electronic devices in the data transmission group. At least an access server is communicated and coupled with the electronic devices, when the rest of the electronic devices receive a command, the rest of the electronic devices output metadata to the access server, and the receiving end receives the metadata via the access server, one of the electronic devices is used as a transmitting end, the receiving end requests for a physical file corresponding to the metadata from the transmitting end according to the metadata and the transmitting end transmits the physical file to the access server, and then the access server transmits the physical file to the receiving end.

A data transmission system is provided, which includes a plurality of electronic devices and a verification server. The verification server is communicated and coupled with the electronic devices, the electronic devices are verified by the verification server, the verified, electronic devices form a data transmission group; one of the electronic device in the data transmission group is used as a connection receiving end, the connection receiving end transmits a bidirectional connection request to the rest of electronic devices in the data transmission group via the verification server, when the rest of the electronic devices receive the request, the rest of the electronic devices form a bidirectional connection with the connection receiving end, and the connection receiving end receives the metadata from the rest of the electronic devices via the bidirectional connection, and one of the rest of the electronic devices sending the metadata is used as a transmitting end, the receiving end requests for the physical file corresponding to metadata from the transmitting end according to the metadata, and the transmitting end transmits the physical file to the receiving end.

A data transmission method applied to a data transmission system is provided, and the data transmission system includes a plurality of electronic devices, a verification server and at least an access server. The data transmission method includes the following steps: (a) verifying the electronic devices in the data transmission system by the verification server, forming a data transmission group by the verified electronic devices, and the verified electronic devices share internal metadata with each other; (b) determining whether the data transmission system operates at the Internet or the local LAN when anyone of the electronic device requesting for the physical file according to the metadata; (c) regarding one of the electronic devices in the data transmission group as a transmitting end and uploading the physical file corresponding to the metadata to the access server by the transmitting end if the data transmission system operates at the Internet, and regarding the rest of the electronic devices in the data transmission group as a receiving end, and downloading the physical file from the access server by the receiving end; and (d) transmitting the physical file corresponding, to metadata to the receiving end by the transmitting end if the data transmission system operating at the local LAN.

### BRIEF DESCRIPTION OF THE DRAWINGS

FIG. 1 is a schematic diagram showing a data transmission system in an embodiment;

FIG. 2 is a schematic diagram showing a data transmission system in another embodiment;

FIG. 3 is a schematic diagram showing a transmission process of a data transmission method in an embodiment;

FIG. 4 is a schematic diagram showing a transmission process of a data transmission method in another embodiment; and

FIG. 5 is a schematic diagram showing a receiving process of a data transmission method in an embodiment;

### DETAILED DESCRIPTION OF THE EMBODIMENTS

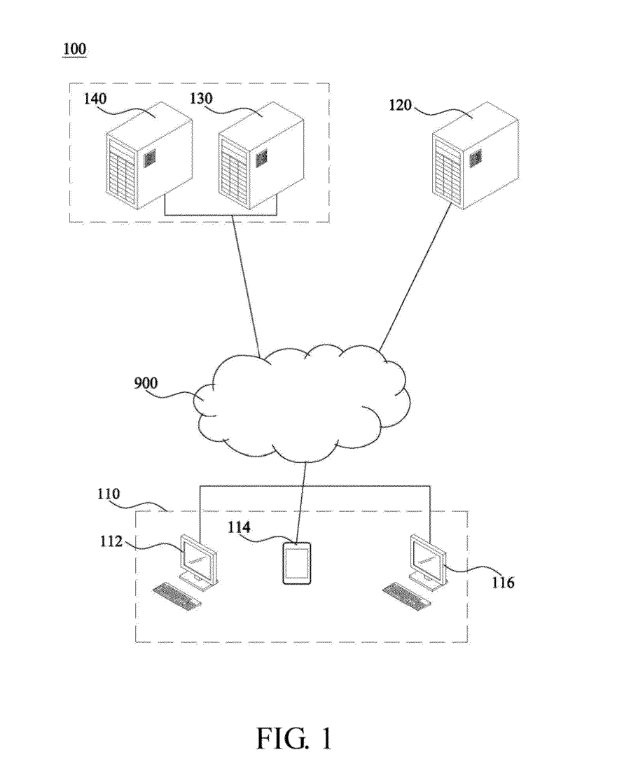

FIG. 1 is a schematic diagram showing a data transmission system 100 in an embodiment. As shown in FIG. 1, the data transmission system 100 includes a plurality of electronic devices 112, 114, and 116, a verification server 120, and a plurality of access servers 130 and 140. In this embodiment, the verification server 120 is communicated and coupled with the electronic devices 112 to 116 via the Internet 900, and moreover, the access servers 130 and 140 are communicated and coupled with the electronic devices 112 to 116 via the Internet 900.

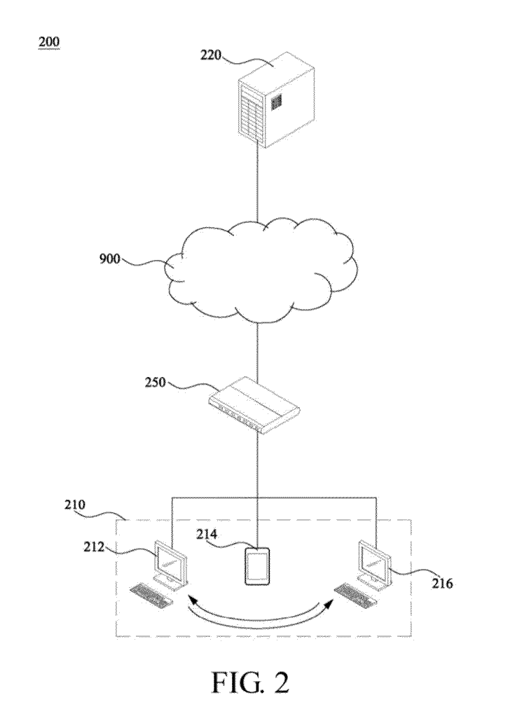

Moreover, FIG. 2 is a schematic diagram showing a data transmission system 200 in another embodiment. Compared with the data transmission system 100 in FIG. 1, the data transmission system 200 in FIG. 2 does not include the access servers 130 and 140. In the embodiment, the verification server 120 is communicated and coupled with the electronic devices 212 to 216 via the Internet 900 and a Hub 250. Moreover, the electronic devices 212 to 216 are communicated and coupled with each other via the Hub 250. In other words, the electronic devices 212 to 216 are communicated and coupled with each other via, the local LAN, which is not limited herein.

Please refer to FIG. 1 and FIG. 2. The electronic devices 112 to 116 or 212 to 216 are communicated and coupled with each other via the Internet or the local LAN, and each of the electronic devices 112 to 116 or 212 to 216 has a grouping application. A user exchanges data via the grouping application of the electronic devices 112 to 116 or 212 to 216. Each of the electronic devices with the grouping application includes an account and a password for authentication.

Therefore, the user can login multiple different electronic devices via a group of an account and a password. When the user logins via the account and the password, each of the electronic devices is automatically connected to the verification server 120 to verify the account. After the electronic devices 112 to 116 are verified, the electronic devices 112 to 116 or the electronic devices 212 to 216 form a data transmission group 110 or 210 with each other via the Internet or the local LAN, which is not limited herein.

A data transmission method of the data transmission group 110 or 210 is shown as following. Please refer to FIG. 1 and FIG. 2. In the data transmission group 110 or 210, any one of the electronic devices is used as a transmitting end to transmit an internal file, such as a film, a picture or a physical file in any other type, to any other electronic devices in the data transmission group 110 or 210. Meanwhile, any electronic device in the data transmission group 110 or 210 also can be used as a receiving end to receive the file from the other electronic devices in the same data transmission group 110 or 210. The data can be transmitted and shared in the different electronic devices by the data transmission group.

Please refer to FIG. 1. First, the electronic devices 112 to 116 are connected to the verification server 120 and verified, and after verified, the electronic devices 112 to 116 form a data transmission group 110. The electronic device 116 can be used as a receiving end to transmit commands via the verification server 120 and requests metadata from the rest of the electronic devices in the data transmission group 110 (such as the electronic devices 112, 114), and the rest of the electronic devices such as the electronic devices 112, 114) converts the a physical file to be shared, such as a film, a picture, a music file, to the metadata, and then transmits the metadata to the access server 130. Then, the receiving end (such as the electronic device 116) receives the metadata which is transmitted from the rest of the electronic devices such as the electronic devices 112 and 114) from the access server 130.

In the embodiment, the receiving end (such as the electronic device 116) can receive the metadata, and the user may see the metadata of the physical file to be shared by the rest of the electronic devices at the screen of the receiving end. The metadata is description information related to the physical file.

In the embodiment, one of the rest of the electronic devices (such as the electronic devices 112, 114) is used as a transmitting end. Practically, the metadata includes assigning a transmitting end (such as the electronic device 112) to transmit the physical file to a specific access server 130. Therefore, when the transmitting end (such as the electronic device 112) receives a command sent from the receiving end, the transmitting end (such as the electronic device 112) uploads the physical file to the access server 130 firstly, and then the physical file is transmitted to the receiving end (such as the electronic device 116) by the access server 130. By the transmitting mode, the user may use a plurality of electronic devices at the same time, and the electronic devices are automatically connected via the grouping application. Consequently, the physical file (such as a film, a picture, and a music file) can be transmitted and shared between the electronic devices simply.

Moreover, the physical file is transmitted by the assigned access server 130 and 140 in the data transmission system 100. When the receiving end receives the physical file, the access server 130 and 140 does not store the physical file, and deletes the physical file to avoid data leaking.

in the embodiment, the data transmission system 100 may use a free cloud disk as the access server 130 and 140 to save cost. The cloud disk may be a Google cloud disk, Dropbox, SugarSync, SkyDrive and so on. However, the type of the file which can be stored in the cloud disk is limited, therefore, the transmitting end in the data transmission system 100 is used to modify the file name extension of the physical file to make the type of the physical file able to be stored in the access server 130 and 140.

When transmitting the files, a suggestion may be provided for the user to choose an access server which is currently optimal to upload the files according to the characteristic of the file or the capacity of the Cloud Storage Space. The data transmission system 100 includes an another access server 140 communicated and coupled with the electronic devices 112 to 116, the transmitting end (such as the electronic device 112) determines that the physical file is transmitted to the access server 130 or the access server 140 according to an allowed upload capacity, an upload speed, or an available capacity. The allowed upload capacity is the capacity offered by the access serve to the user. Taking the Dropbox as the access server for example, the capacity offered to the user is 2 GB, 2 GB is the allowed upload capacity. The upload speed is the speed of the transmitting end uploading the physical file to the access server. When 1 GB is used in the allowable upload capacity (2 GB), the rest 1 GB is the available capacity.

The physical file can be uploaded to the optimal Cloud Sever by the method in the embodiment, and thus the user uploads the file easier.

The mode of coupling the electronic devices 212 to 216 with each other via the local LAN will be illustrated hereinafter. Please refer to FIG. 2. In another embodiment, the electronic devices 212 and 216 are coupled with each other via the Internet, and the difference between the coupled electronic devices 212 to 216 and the coupled electronic devices 112 to 116 via the Internet is that the transmitting end in the data transmission group 210 (such as the electronic device 212) transmits the physical file to the receiving end (such as the electronic device 216) directly but not through the access server 130 and 140. Therefore, in the embodiment, the access server 130 and 140 is not needed in the data transmission system 200.

Besides the above file sharing method motioned in FIG. 1, the data transmission system includes another method of sharing and transmitting file. Please refer to FIG. 2, the electronic devices 212 to 216 are verified by the verification server 220, and after forming a data transmission group 210, one of the electronic devices (such as the electronic device 216) in the data transmission group 210 is used as a connection receiving end, and the connection receiving end sends a bidirectional connection request to the rest of the electronic devices (such as the electronic device 212) in the data transmission group 210 via the verification server 220. When the rest of the electronic devices receive the command, the rest of the electronic devices form a bidirectional connection with the receiving end. At the time, the connection receiving end requests the rest of the electronic devices for the metadata via the bidirectional connection. Therefore, the user can see the file information (such as a video file, a picture, and a music file) to be shared by the rest of the electronic devices (such as the electronic device 212) via the connection receiving end, and the file information shown to the user is the metadata corresponding to the physical file but not the physical file.

Then, the rest of the electronic devices (such as the electronic device 212) is used as a transmitting end, and the connection receiving end requests for the physical file corresponding to the metadata from the transmitting end, and the transmitting end transmits the physical file to the connection receiving end.

In the embodiment, when the data transmission system 200 operates at Window operating system, the data transmission has limitations by the operating system. For example, if data is transmitted between a sever and a client, when the grouping application of the client operates at a background mode and the sever transmits the physical file to the client, the client will be waken up to deal with the data. However, when the client transmits the physical file to the sever and the grouping application of the sever operates at the background mode, the sever would not be waken up, and the client is failed to transmit the physical file.

Consequently, a method of the transmitting end transmitting the physical file to the connection receiving end via the bidirectional connection is provided. When the transmitting end establishes a first connection to the connection receiving end to transmit the physical file to the connection receiving end, the connection receiving end establishes a second connection to the transmitting end. The first connection and the second connection are regarded as opposite and unidirectional connection lines to form a data circle. Therefore the limitation of the data transmission system 200 operating at the Window operation system is overcome, and it can make sure that when the grouping application of the transmitting end or the receiving end at the background mode, the transmitting end or the receiving end can be waken up when they receives data.

The specific implementation modes of the electronic devices 112 to 116 or 212 to 216 being coupled with each other via the Internet or the local LAN are illustrated respectively in the aforementioned embodiments. The common implementation mode of the electronic devices 112 to 116 or 212 to 216 communicated and coupled with each other via the Internet or local LAN is descripted in the following.

In the common implementation mode of the electronic devices coupled with each other via the Internet and local LAN, the metadata includes at least one of a file name, a catalogue name, a file time, a file size, a label, an album name, a geographical coordinate, a thumbnail and a screenshot. The file time is the time of creating the file or the latest time of modifying the file. Taking a picture file as an example, its file time may be a shooting time of the picture. The album name may be a name of a music album which a music file belongs to. The geographical coordinates may be a longitude value and a latitude value, for example, some cameras adds the information of the longitude value and the latitude value into the picture. The thumbnail may be a thumbnail of an image file, and the screenshot may be the screenshot of a film file.

The metadata can be displayed on the screen of the electronic device. The metadata may be displayed by page according to the type of the files (for example, the metadata of the picture, the film, the music, and the file is displayed on the corresponding page) or all metadata is displayed at one page. The metadata can represent the description of the corresponding physical file, and it facilitates the users browsing the electronic device.

In the embodiment, when the receiving end receives the metadata, the rest of the electronic devices can be used as a transmitting end, and the receiving end requests for the physical file corresponding to the metadata from the transmitting end. Moreover, the receiving end further can be used to search the metadata, the receiving end compares an input search term with the metadata to search the corresponding physical file and note the user the physical file corresponding to the search term, and the receiving end requests for the physical file corresponding to the search term from the transmitting end. The user may input the file name in the receiving end, and then the receiving end compares the metadata of the file name with the file name inputted from the user to search the physical file corresponding to search term.

Furthermore, the user may input the catalogue name or the label information in the receiving end, and the receiving end compares the metadata of the file with the catalogue name or the label information input by the user to search the physical file including the catalogue name or the label information.

Furthermore, the user may input the album name in the receiving end and searches all of the music files in the album. Furthermore, the user may choose an object of the thumbnails or the screenshots of the metadata of the picture files or the film files via the receiving end, such as a human face, and the receiving end compares the thumbnail and/or the screenshot with the chosen object to search the picture file and the film file including the object.

Furthermore, the geographical coordinates may be added into the picture when the picture is taken, such as the longitude value and the latitude value. By the converting between the geographical coordinates and the address information an address searching function is provided for the user to search a picture taken in a specific address by inputting the address information. Some severs are used by public to convert the geographical coordinates and the address information mutually, such as, Google map application programming interlace (Google map API). The address information may be the address of a city and a street, such as “Section two, Roosevelt Road, Taipei”. The address information may be a famous land mark, such as “Taipei Building 101”.

There are two methods to search the address, and the invention is not limited thereto. One is that the user inputs the address information at the receiving end, the receiving end converts the address information into the geographical coordinates, such as the longitude and the latitude, and searches the file including the geographical coordinates corresponding to the converted geographical coordinates. The receiving end may estimate the distance between the converted geographical coordinates and the geographical coordinates included in the picture. If the distance is smaller than a threshold value, the receiving end determines that the converted geographical coordinates are corresponding to the geographical coordinates included in the picture.

The second method is that user inputs the address information in the receiving end, and the receiving end converts the geographical coordinates of the picture into the address information and searches the picture whose address information is corresponding to the inputted address information.

Then, the user inputs the time information at the receiving end, and the receiving end converts the time information to the corresponding time or the time region and searches the file whose time information is corresponding to the converted time or the time region in the metadata. For example, when the user inputs “Christmas Day”, it may be converted into “December 25”, and the pictures or films taken on December 25 are searched. When the user inputs “Spring”, it may be converted into the time region “March 1 to May 31”, and the pictures or the film files taken on this time region are searched.

The file name searching, the catalogue name searching, the label searching, the album name searching, the picture searching, the address searching, the time searching mentioned above may be used in combination to get an accurate result. For example, if “Spring” is used to search, all the picture taken in Spring may be searched. If the term “Spring, 2008, Taipei” are used to search, only the picture taken in 200$ and in Taipei can be searched.

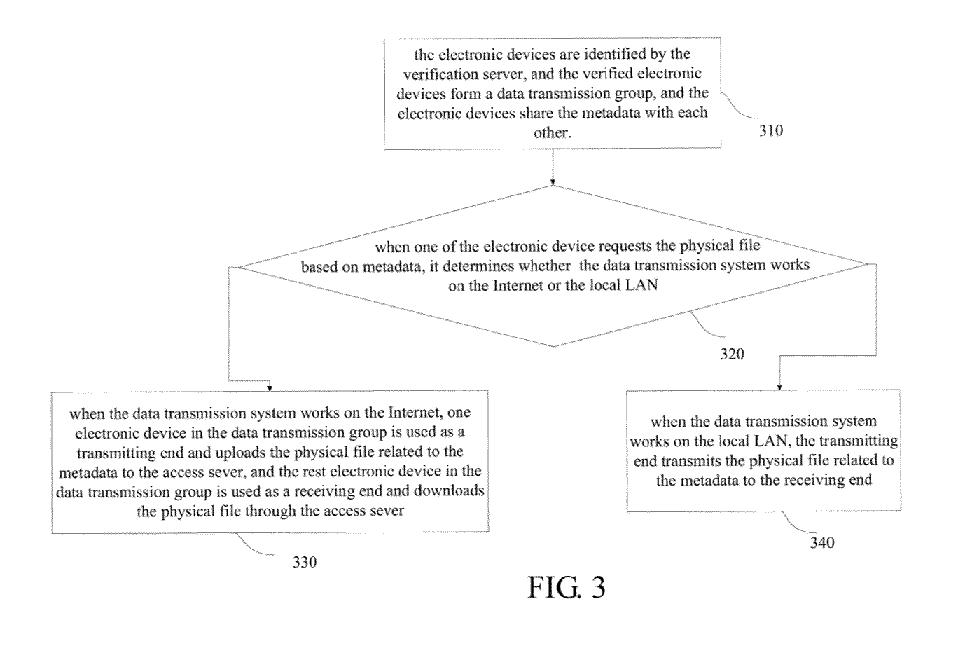

FIG. 3 is a schematic diagram showing a transmission process of a data transmission method in an embodiment. The data transmission method 300 is used in the data transmission system 100 and 200, and the components of the data transmission system 100 and 200 are introduced above, which is omitted herein.

As shown in FIG. 3, the data transmission method includes following steps. First, in step 310, the electronic devices 112 to 116, and 212 to 216 in the data transmission system 100, 200 are verified by the verification server 120 and 220, respectively; and the verified electronic devices 112 to 116, and 212 to 216 form a data transmission group 110 and 120, respectively, and the electronic devices 112 to 116, and 212 to 216 share the internal metadata with each other, respectively.

Next, in step 320, when any one of the electronic devices requests for physical file according to the metadata, whether the data transmission system 100 and 200 operates at the Internet or the local LAN is determined via any one electronic device. In step 330. When the data transmission system 100 operates at the Internet, one electronic device in the data transmission group 110 is used as a transmitting end, and uploads the physical file corresponding to the metadata to one of the access server 130 and 140, and the rest of the electronic devices in the data transmission group 110 is used as the receiving end and downloads the physical file by accessing one of the access server 130 and 140.

Moreover, in step 340, when it determines that the data transmission system 200 operates at the local LAN, the transmitting end transmits the physical file corresponding to the metadata to the receiving end directly. Since the operation method of the internal components in the data transmission system 100 and 200 is illustrated in FIG. 1 and FIG. 2, it is not described again for concise purpose.

As mentioned above, according to the data transmission method 300, it can quickly determines that which network the data transmission system operates at, and an appropriate data transmission method is adaptively provided to the data transmission system to transmit data.

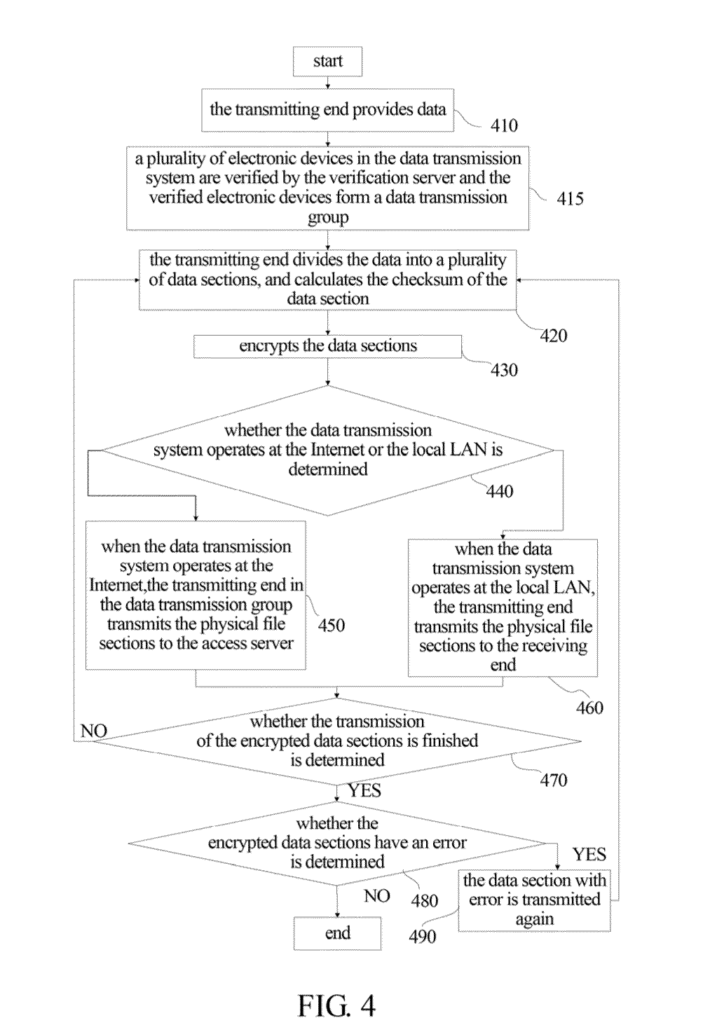

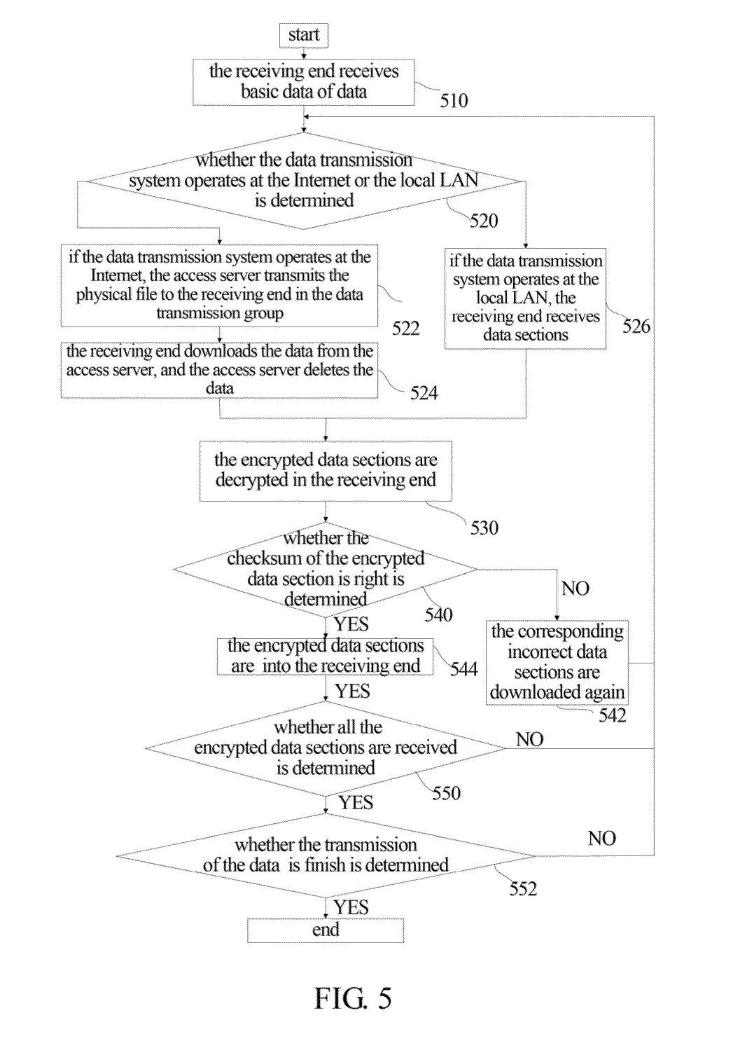

FIG. 4 is a schematic diagram showing the transmission process of a data transmission method in another embodiment; FIG. 5 is a schematic diagram showing the receiving process of a data transmission method in another embodiment.

In order to make the data transmission method in the embodiment easily understood, as shown in FIG. 1 and FIG. 4, first, the transmitting end provides data (step 410), the data includes the physical file and basic data. Next, the verification server verifies a plurality of electronic devices in the data transmission system, and the verified electronic devices form a data transmission group (step 415). The transmitting end divides the data into a plurality of data sections, and calculates the checksum of the data sections (step 420), and encrypts the data sections (step 430).

Then, whether the data transmission system operates at the Internet or the local LAN is determined (step 440). When the data transmission system operates at the Internet, the transmitting end in the data transmission group transmits the physical file sections to the access server (step 450). Conventionally, no appropriate mechanism exists to inform the user how to choose an optimal access server to upload the file when a plurality of access servers exist. In the embodiment of the invention, when a plurality of access servers exist, the transmitting end in the data transmission group determines an access server to transmit the physical file according to the allowed upload capacity, the upload speed or the remaining capacity of the access servers. Consequently, the physical file can be uploaded to the optimal access server according to the mechanism in the embodiment, and it is convenient for user to upload file.

Moreover, when the data transmission system operates at the local LAN, the transmitting end transmits the physical file sections to the receiving end directly (step 460). Next, whether the transmission of the encrypted data sections is completed is determined (Step 470). If the transmission of the encrypted data sections is completed, whether the encrypted data sections have an error is determined (step 480); if the transmission of the encrypted data sections is not completed, the method goes back to step 420.

After the step 480, when one of the encrypted data sections has an error, the data section with the error is rebuilt to form a correct data section and the correct data section is transmitted (step 490); if none of the encrypted data sections has errors, the transmission process 200 of the data transmission method goes to end.

In order to make the data transmission method easily understood, as shown in FIG. 1 and FIG. 5, first, the receiving end receives basic data of the data (step 510). Next, whether the data transmission system operates at the Internet or the local LAN is determined (step 520). If the data transmission system operates at the Internet, the access server transmits the physical file to the receiving end in the data transmission group (step 522); if the data transmission system operates at the local LAN, the receiving end receives the data sections (step 526). In one embodiment, the transmitting end uploads data to the access server, the receiving end downloads data from the access server, and after the receiving end downloads the data from the access server, the access server deletes the data (step 524).

Moreover, the encrypted data sections are decrypted in the receiving end (step 530). Next, whether the checksum of the encrypted data sections is right is determined (step 540). If the checksum of the encrypted data sections is incorrect, the corresponding incorrect data section is rebuilt to form a correct data section and the correct data section is downloaded (step 542); if the checksum of the encrypted data sections is correct, the encrypted data sections are written into the receiving end (step 544).

Then, whether all the encrypted data sections are received is determined (step 550). If all the encrypted data sections is received, whether the transmission of the data is finish is determined (step 552); if the receiving of the encrypted data section is not completed, the method goes back to step 520.

In step 552, if the transmission of the data is not completed, the method goes go back to step 520; if the transmission of the data is completed, the data transmission process 300 goes to end.

The data transmission method in embodiments can be achieved by software, hardware or firmware. For example, the execution speed and the accuracy may be higher when the hardware is chosen; the design flexible may be better when the software or the firmware is chosen; the software, the hardware or the firmware may be used corporately, which is not limited herein.

In sum, the data transmission method in embodiments can solve a problem that a file offering end in the FTP needs a public and fixed Internet address. Moreover, compared to the conventional FTP, a plurality of electronic devices can be connected automatically via the grouping application, and the user has better user experience. Since the physical file does not need not to be integrally stored in the Cloud Storage Space, the risk of data leakage is reduced. A free cloud disk also can be used as the access sever to save cost.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A data transmission system, comprising:
a plurality of electronic devices;
an verification sever communicated and coupled with the electronic devices, wherein the electronic devices are verified by the verification server, and a data transmission group are formed by the verified electronic devices, a receiving end is represented by one of the electronic devices in the data transmission group which sends a command to the verification server, then the verification server receives and transmits the command to the rest of the electronic devices in the data transmission group; and
at least an access server communicated and coupled with the electronic devices, wherein metadata is output to the access server when the rest of the electronic devices receive the command, the receiving end receives the metadata via the access server, one of the rest of the electronic devices is used as a transmitting end which requests for a physical file corresponding to the metadata, then the transmitting end transmits the physical file to the access serve, and the access server transmits the physical file to the receiving end.

2. The data transmission system according to claim 1, wherein the transmitting terminal uploads the physical file to the access server, and the receiving end downloads the physical file from the access server.

3. The data transmission system according to claim 2, wherein the access server deletes the physical file after the receiving end downloads the physical file from the access server.

4. The data transmission system according to claim 1, wherein the transmitting end modifies the file name extension of the physical file thus the file type of the physical file is acceptable and stored by the access server.

5. The data transmission system according to claim 1, wherein the receiving end outputs a request command to the verification server, the verification server receives and transmits the request command to the transmitting end, the transmitting end transmits the physical file to the access server, and the access server outputs the physical file to the receiving end.

6. The data transmission system according to claim 1, wherein the metadata includes at least one of a file name, a catalogue name, a file time, a file size, a label, an album name, a geographical coordinates, a thumbnail and a screenshot.

7. The data transmission system according to claim 6, wherein the receiving end searches the metadata via the access server, notes the searched physical file, and the receiving end sends requests to the transmitting end for the searched physical file.

8. The data transmission system according to claim 6, wherein the physical file is a picture or a film and represents as an object including thumbnails or the screenshots, one of the objects is selected via the access server, and the physical file having the object is further searched by the receiving end.

9. The data transmission system according to claim 6, wherein when the physical file is a picture, an address information is inputted via the receiving end and converted to a geographical coordinate by the receiving end, the receiving end searches the metadata corresponding to the geographical coordinate via the access server and requests for the corresponding physical file from the transmitting end according to the metadata which is corresponding to the geographical coordinate.

10. The data transmission system according to claim 6, wherein when a time information is inputted and converted into a time or a time region by the receiving end, the receiving end searches the metadata corresponding to the time or the time region via the access server, and requests for the physical file from the transmitting end according to the metadata corresponding to the time or the time region.

11. The data transmission system according to claim 1, further comprising:
another access server communicated and coupled with the electronic devices, wherein the transmitting end determines to transmit the physical file to the access server or the another access server according to an allowed upload capacity, an upload speed, or an available capacity of the access server or the another access server.

12. A data transmission system, comprising:
a plurality of electronic devices; and
a verification server communicated and coupled the electronic devices, wherein the electronic devices are verified by the verification server, and a data transmission group are formed by the verified electronic devices;
wherein one of the electronic devices in the data transmission group is used as a receiving end which transmits a bidirectional connection request to the rest of the electronic devices in the data transmission group via the verification server, when the rest of the electronic devices receive the request, a bidirectional connection is formed with the receiving end, and the receiving end requests for a metadata from the rest of the electronic devices via the bidirectional connection, and one of the rest of the electronic devices is used as a transmitting end, the receiving end requests for a physical file corresponding to the metadata from the transmitting end according to the metadata, and the transmitting end transmits the physical file to the receiving end.

13. The data transmission system according to claim 12, wherein when the transmitting end establishes a first connection to the receiving end for transmitting the physical file to the receiving end, the receiving end establishes a second connection to the transmitting end, and the first connection and the second connection are regarded as opposite and at unidirectional connection lines thus to form a data circle.

14. The data transmission system according to claim 12, wherein the metadata includes at least one of a file name, a catalogue name, a file time, a file size, a label, an album name, a geographical coordinates, a thumbnail, and a screenshot.

15. The data transmission system according to claim 14, wherein the receiving end is used to search the metadata and notes the physical file corresponding to the search, the receiving end requests for the physical file corresponding to the search from the transmitting end.

16. The data transmission system according to claim 14, wherein the physical file is a picture or a film, and an object in the thumbnail or the screenshot is chosen by the receiving end, the receiving end searches the physical file including the object via the access server.

17. The data transmission system according to claim 14, wherein when the physical file is a picture, an address information is inputted via the receiving end and converted to a geographical coordinate by the receiving end, the receiving end searches the metadata corresponding to the geographical coordinate and request for the corresponding physical file from the transmitting end according to the metadata which is corresponding to the geographical coordinate.

18. The data transmission system according to claim 14, wherein a time information is inputted and converted to a time or a time region by the receiving end, the receiving end searches the metadata corresponding to the time or the time region, and requests for the physical files from the transmitting end according to the metadata corresponding to the time or the time region.

19. A data transmission method applied to a data transmission system, wherein the data transmission system includes a plurality of the electronic devices, a verification server, and at least one access server, the data transmission method comprising steps of:
(a) verifying the electronic devices in the data transmission system by the verification server and forming a data transmission group by the verified electronic devices, wherein the verified electronic devices share internal metadata with each other;
(b) determining whether the data transmission system operates at the Internet or as local LAN when anyone of the electronic devices requests for a physical file according to the metadata;
(c) regarding one of the electronic devices in the data transmission group as a transmitting end and uploading the physical file corresponding to the metadata to the access server by the transmitting end if the data transmission system operates at the Internet, and regarding the rest of the electronic devices as a receiving end and downloading the physical file from the access server by the receiving end; and
(d) transmitting the physical file corresponding to the metadata to the receiving end by the transmitting end if the data transmitting system operates at the local LAN.

20. The data transmission method according to claim 19, wherein the step (c) further comprising:
uploading a data which including the physical file to the access server by the transmitting end, and downloading the data from the access server by the receiving end.

21. The data transmission method accordion to claim 20, wherein the access server deletes the data when the receiving end downloads the data from the access server.

22. The data transmission method according to claim 20, wherein the transmitting end modifies the file name extension of the data thus the file type of the data is acceptable and stored in the access server.

23. The data transmission method according to claim 20, wherein the method further comprises:
transmitting the data to the receiving end via a bidirectional connection by the transmitting end.

24. The data transmission method according to claim 19, wherein the transmitting end establishes a first connection to the receiving end for transmitting the data to the receiving end, the receiving end establishes a second connection to the transmitting end.

25. The data transmission method according to claim 20, wherein the method comprises:
dividing the data into a plurality of data sections and calculating the checksum of the data sections; and
encrypting the data sections.

26. The data transmission method according to claim 25, wherein the method comprises:
transmitting the data sections to the access server by the transmitting end and transmitting the data sections to the receiving end by the access server when the data transmission system operates at the Internet; and
transmitting the data sections to the receiving end by the transmitting end when the data transmitting system operates at the local LAN.

27. The data transmission method according to claim 26, wherein after the receiving end receives the data, the method further comprises:
determining whether transmission of the encrypted data sections is completed;
determining whether an error exists in the encrypted data sections if the transmission of the encrypted data sections is completed; and
rebuilding the data sections having the error if the error exists in one of the encrypted data sections.

28. The data transmission method according to claim 27, further comprising:
decrypting the encrypted data sections;
determining whether the checksum of the encrypted data sections is correct; and
rebuilding the data sections having the error if the checksum of the encrypted data sections is not correct.

29. The data transmission method according to claim 28, further comprising:
writing the encrypted data sections to the receiving end if the checksum of the encrypted data sections is correct;
determining whether all the encrypted data sections are received; and
determining whether the transmission of the data is completed if all the encrypted data sections are received.
